(19) United States
(12) Patent Application Publication
(10) Pub. No.: US 2008/0084386 A1
(43) Pub. Date: Apr. 10, 2008

(54) Light-weighted and minimized pointing device

(75) Inventors: I-Hau Yeh, Hsinchu City (TW); Jia-Yih Li, Taichung City (TW)

Correspondence Address: TROXELL LAW OFFICE PLLC, SUITE 1404, 5205 LEESBURG PIKE, FALLS CHURCH, VA, 22041, US

(73) Assignee: ELAN MICROELECTRONICS CORP., Hsinchu City (TW)

(21) Appl. No.: 11/603,042

(22) Filed: Nov. 22, 2006

(30) Foreign Application Priority Data
Oct. 5, 2006 (TW) 095217866

(51) Int. Cl. G09G 5/08

(52) U.S. Cl. 345/157

(57) ABSTRACT

The present invention is a pointing device, which is a kind of pointing stick. The pointing device is light weighted and has a small size. The pointing device is applied to a portable device or a remote controller so that the size of the equipment can be minimized.

### FIELD OF THE INVENTION

The present invention relates to a pointing device; more particularly, relates to applying a pointing device, which is light-weighted and minimized, on a portable device or a remote controller.

### DESCRIPTION OF THE RELATED ART

A general pointing stick is used in a notebook computer or a keyboard only. There is no related applications other than these two until now.

A portable multimedia player, a remote controller and a personal digital assistant (PDA) use five-directional keys or a pointing pad to control a pointer. But the usage is not friendly and the size is not minimized, where size and weight are most crucial to a portable device.

In a word, although the above prior arts control the pointer, the size is big, not minimized. Hence, the prior arts do not fulfill users' requests on actual use.

### SUMMARY OF THE INVENTION

The main purpose of the present invention is to replace a pointing pad or a general pointing stick with a pointing device which is light weighted and minimized.

To achieve the above purpose, the present invention is a light-weighted and minimized pointing device which is a pointing stick deposed on a portable device, such as a PDA, a multimedia remote controller, such as a remote controller for a media center or a car personal computer. Accordingly, a novel light-weighted and minimized pointing device is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is the view showing the first preferred embodiment according to the present invention;

FIG. 2 is the view showing the second preferred embodiment; and

FIG. 3 is the view showing the third preferred embodiment.

### DESCRIPTIONS OF THE PREFERRED EMBODIMENTS

The following descriptions of the preferred embodiments are provided to understand the features and the structures of the present invention.

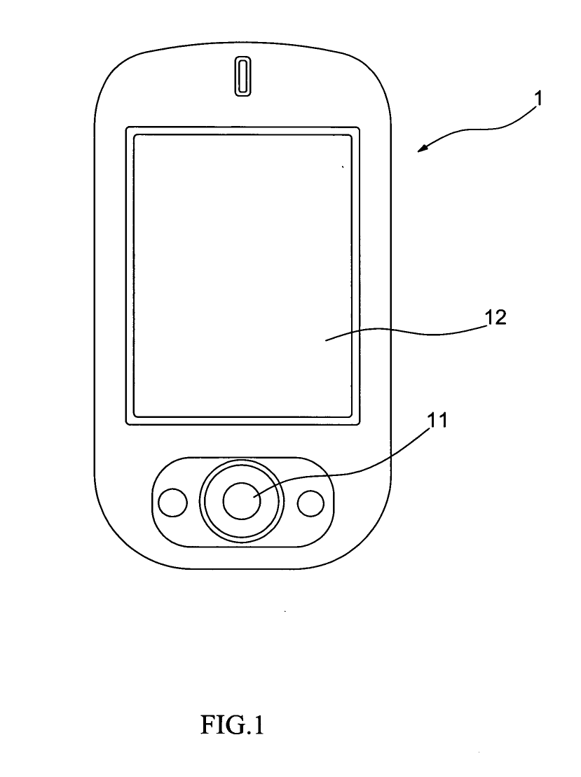

Please refer to FIG. 1, which is a view showing a first preferred embodiment according to the present invention. As shown in the figure, the present invention is a light-weighted and minimized pointing device. The first preferred embodiment is a pointing device 11 equipped on a personal digital assistant (PDA) 1; and the pointing device 11 is a pointing stick. A user touches on the pointing device 11 to control a pointer on a display 12 of the PDA 1 and to further select a function. The present invention can be also used in a portable device, such as a portable multimedia player or a mobile phone.

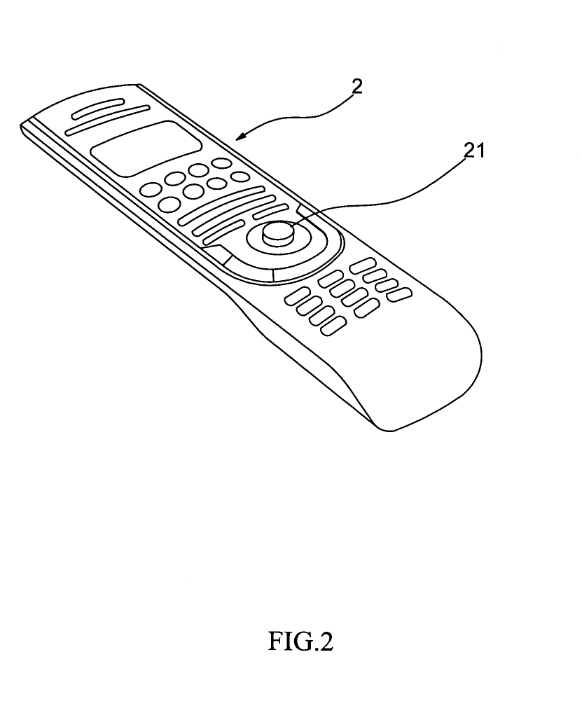

Please refer to FIG. 2, which is a view showing a second preferred embodiment. As shown in the figure, the second preferred embodiment is a pointing device 21 applied to a remote controller 2, where a user touches the pointing device 21 to remotely select a TV channel and to control sound volume.

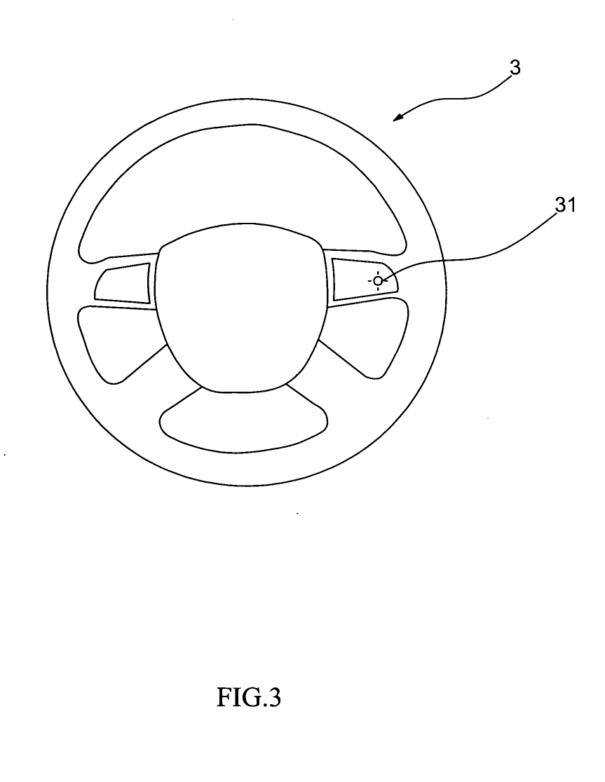

Please refer to FIG. 3, which is a view showing a third preferred embodiment. As shown in the figure, the third preferred embodiment is a pointing device 31 deposed on a steering wheel 3. When a user is driving on a road, the pointing device 31 is touched to control a car personal computer and a global position system without looking for a controller and therefore dangers are prevented.

To sum up, the present invention is a light-weighted and minimized pointing device, where the pointing device is used in a portable device or a remote controller with light weight and minimized size.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A light-weighted and minimized pointing device, being a pointing stick deposed on a device selected from a group consisting of a portable device and a remote controller.

2. The device according to claim 1, wherein said portable device is a portable multimedia player.

3. The device according to claim 1, wherein said portable device is a personal digital assistant.

4. The device according to claim 1, wherein said remote controller controls a media center.

5. The device according to claim 1, wherein said remote controller controls a car personal computer.
